(19) United States
(12) Patent Application Publication
(10) Pub. No.: US 2023/0358123 A1
(43) Pub. Date: Nov. 9, 2023

(54) REINFORCEMENT LEARNING-BASED DECISION OPTIMIZATION METHOD OF OILFIELD PRODUCTION SYSTEM

(71) Applicants: University of Science and Technology Beijing, Beijing (CN); Beijing Zhongke Zhishang Technology Co., Ltd., Beijing (CN)

(72) Inventors: Hongqing SONG, Beijing (CN); Shuyi DU, Beijing (CN); Liying SONG, Beijing (CN); Jiulong WANG, Beijing (CN); Ming YUE, Beijing (CN)

(21) Appl. No.: 18/143,660

(22) Filed: May 5, 2023

(30) Foreign Application Priority Data
May 7, 2022 (CN) 202210493119.1

(51) Int. Cl. E21B 43/16; E21B 43/25

(52) U.S. Cl. CPC E21B 43/168; E21B 43/255

(57) ABSTRACT

The present disclosure provides a reinforcement learning-based decision optimization method of an oilfield production system, including: collecting dynamic production data of an oilfield production site to establish a data cube for reservoir production optimization; training a preset machine learning model based on the data cube to obtain a reinforcement learning-based reservoir injection-production system surrogate model configured to predict oil production according to the dynamic production data available on site; constructing an evaluation function for production optimization of a gas injection reservoir; establishing, during a process of production optimization, an enforced constraint model based on input parameters and a boundary constraint condition; and with the constraint model and the boundary constraint condition as constraints, the reservoir injection-production system surrogate model as a basis, and the evaluation function as an optimization direction, searching reservoir production optimization schemes for an optimal production scheme.

### CROSS REFERENCE TO RELATED APPLICATION

This patent application claims the benefit and priority of Chinese Patent Application No. 202210493119.1, filed on May 7, 2022, the disclosure of which is incorporated by reference herein in its entirety as part of the present application.

### TECHNICAL FIELD

The present disclosure relates to the technical field of oilfield development, and in particular to a reinforcement learning-based decision optimization method of an oilfield production system.

### BACKGROUND ART

Production optimization plays an essential role in closed-loop reservoir management, which can directly influence the sustainability, efficiency, safety and profitability of reservoir development. At present, it has always been the focus for the oil field to seek a best injection mode of injection well, so as to increase oil production as much as possible while ensuring production safety and green environmental protection.

Regarding existing methods for reservoir production optimization, the numerical reservoir simulator is established mainly based on complex geological models and multiphase flow mechanism; through a large amount of parameter adjustment, the output of the numerical simulator can be historically fitted with the actual production; and the injection parameters are adjusted to better predict the future production, which enables optimized production. The numerical reservoir simulator is a reservoir model developed in accordance with geological explanations and existing understanding of general physical laws about fluid flow in porous media, in which many hypotheses, simplification, experiences and preconceptions are encompassed. In view of the complexity of reservoir geology, the uncertainty of multiphase flow, and the limitation of exploration technology, the numerical reservoir simulator can hardly simulate the real reservoir completely, and may fail to accurately describe the real situation in most cases; and meanwhile, the simulator involves iterative calculation of tens of thousands of grids, and therefore, the establishment of the simulator and subsequent production optimization will take a lot of time. In addition, the iterative errors based on tens of thousands of grids should also be considered.

Therefore, traditional physics-based methods have limitations in calculation accuracy and time consumption.

### SUMMARY

The present disclosure provides a reinforcement learning-based decision optimization method of an oilfield production system to break through the technical limitations of traditional physics-based methods in terms of calculation accuracy and time consumption.

To solve the above technical problem, the present disclosure provides the following technical solutions:

a reinforcement learning-based decision optimization method of an oilfield production system, including the steps of:

collecting on-site dynamic production data to establish a data cube for reservoir production optimization;

training a preset machine learning model based on the data cube to obtain a reinforcement learning-based reservoir injection-production system surrogate model configured to predict oil production according to the on-site dynamic production data;

constructing an evaluation function for production optimization of a gas injection reservoir;

establishing, during a process of production optimization, an enforced constraint model based on input parameters and a boundary constraint condition; and

with the constraint model and the boundary constraint condition as constraints, the reservoir injection-production system surrogate model as a basis, and the evaluation function as an optimization direction, searching reservoir production optimization schemes for an optimal production scheme.

Further, after obtaining the reservoir injection-production system surrogate model, the method further includes:

based on the reservoir injection-production system surrogate model, quantitatively characterizing connectivity between an injection well and a production well.

Further, said quantitatively characterizing connectivity between an injection well and a production well includes:

firstly, calculating importance of each input variable of the reservoir injection-production system surrogate model to the model, namely, randomly changing the sequence of data of a certain variable in a data set while keeping other variables constant so as to construct a new training set, training the model with the new data set, and calculating an error of a corresponding prediction result;

then calculating a difference value between a prediction error of the model trained based on the new data set and a prediction error of a model trained based on an original data set as sensitivity of a corresponding variable in a data set to a model; and

calculating the connectivity between an injection well and a production well through the following formula:

$${L}_{j} = \frac{E ( {IV}_{j} ) + E ( {IP}_{j} ) + E ( {IM}_{j} )}{{\sum }_{i = 1}^{4} ( E ( {IV}_{i} ) + E ( {IP}_{i} ) + E ( {IM}_{i} ) )}$$

where Lⱼ denotes a connectivity factor between a jth injection well and a production well, E(IVⱼ) denotes sensitivity of a gas injection volume of the jth injection well to a model, E(IPⱼ) denotes sensitivity of injection pressure of the jth injection well to the model, and E (IMⱼ) denotes sensitivity of an injection mode of the jth injection well to the model.

Further, said collecting on-site dynamic production data to establish a data cube for reservoir production optimization specifically includes:

collecting dynamic production data from reservoir production wells and neighboring injection wells, where the dynamic production data of the production wells include: oil production, gas production, gas-oil ratio, well status of shut-in and producing, and choke size, and the dynamic production data of the injection wells include: gas injection volume, injection pressure, and injection mode; and

establishing the data cube for reservoir production optimization by using the collected dynamic production data.

Further, said training a preset machine learning model based on the data cube to obtain a reinforcement learning-based reservoir injection-production system surrogate model configured to predict oil production according to the on-site dynamic production data specifically includes:

extracting from the data cube a data set required for model training, and dividing the data set into training sets and test sets in a ratio of 9:1, where in the data set, the well status of shut-in and producing and choke size of the production wells, as well as the gas injection volume, injection pressure and injection mode of the injection wells are taken as inputs of the model, and oil production, gas production and gas-oil ratio of the production wells are taken as outputs of the model;

constructing a deep neural network-based (DNN-based) machine learning model, where the machine learning model has 3 hidden layers, with each layer having 60 neurons; and

training the machine learning model by adopting the training sets, and testing the trained machine learning model by adopting the test sets to obtain the reinforcement learning-based reservoir injection-production system surrogate model.

Further, the evaluation function is expressed as follows:

$$O ( x ) = exp \{ \frac{{Qo}_{( f ( D , W , θ ) )}}{G O {R}_{( f ( D , W , θ ) )} + 1} \}$$

where O(x) denotes an evaluation function, Qo_{(f(D,W,θ))} denotes oil production, and GOR_{(f(D,W,θ))} denotes a gas-oil ratio.

Further, said establishing an enforced constraint model based on input parameters and a boundary constraint condition specifically includes:

establishing a physical constraint model between injection volume and injection pressure, that is, constructing, with injection volume as an input and injection pressure as an output, and by a machine learning model, an intelligent constraint model S which can predict injection pressure with the injection volume, where a relationship between the injection volume and injection pressure is represented as follows:

IP_pred^{w,t}=S(IV^{w,t},W,θ)

where IP_pred^{w,t} denotes an injection pressure prediction value of a wth injection well at moment t, IV^{w,t} denotes an injection volume of the wth injection well at moment t, W denotes a weight among neurons of a machine learning model, and θ denotes a threshold value in the neurons; besides, a following boundary constraint condition is set for input variables corresponding to the injection well:

IV^{w,t}∈{a*Ave(IV),b*Max(IV)},IP^{w,t}∈{Min(IP),Max(IP)}

where a and b are constraint factors, which respectively have a value range a ∈(0,1) and b ∈(0.5,2); IP^{w,t} denotes injection pressure of a wth injection well at moment t; Ave(IV) denotes an average value of injection volume, Max(IV) denotes a maximum value of injection volume, Min(IP) denotes a minimum value of injection pressure, and Max(IP) denotes a maximum value of injection pressure; and

in addition, a boundary constraint condition of a choke size in production measures is expressed as:

CS^{t}∈{0,AVE(CS)+c*(MAX(CS)−MIN(CS))}

where CS^{t} denotes a choke size of a production well at moment t; AVE (CS) denotes an average value of choke size; c denotes a flow coefficient, MAX(CS) denotes a maximum value of choke size, and MIN(CS) denotes a minimum value of choke size.

Further, said with the constraint model and the boundary constraint condition as constraints, the reservoir injection-production system surrogate model as a basis, and the evaluation function as an optimization direction, searching reservoir production optimization schemes for an optimal production scheme specifically includes:

establishing an injection-production optimization model based on a particle swarm optimization algorithm, where inputs of the injection-production optimization model include injection volume, injection pressure and injection mode of each injection well, and outputs include oil production and gas-oil ratio of a target well;

with a relation model between the injection volume and injection pressure and a boundary constraint condition as constraints, the reinforcement learning-based reservoir injection-production system surrogate model as a basis, and the evaluation function as an optimization direction, searching reservoir production optimization schemes; and

optimizing different injection schemes, calculating, based on the optimized injection scheme, oil production and gas-oil ratio of a production well under corresponding conditions by using the injection-production system surrogate model, searching for Pareto front aiming at reservoir production optimization, and based on the Pareto front, selecting and optimizing the schemes according to different requirements.

Technical solutions provided in the present disclosure achieve at least the following beneficial effects:

1. The present disclosure designs a reinforcement learning-based calculation framework for decision optimization of an oilfield production system. Firstly, an injection-production system surrogate model is established by using injection-production data, which can accurately predict the dynamic production data of a production well according to injection parameters, and complete historical fitting of the on-site monitoring data; and based on the model, an intelligent model of production optimization is constructed to search for the optimal injection mode that can complete the production optimization in the process of oilfield development.

2. The present disclosure provides a surrogate model of an injection-production system. The surrogate model can, based on the machine learning method, accurately predict the production and gas-oil ratio of a production well using the injection variables and production measures of an injection well, without the need for complex geological parameters and geological models.

3. The present disclosure introduces a method for evaluating inter-well connectivity by means of reinforcement learning, which analyzes the importance of input variables based on injection-production surrogate model, and defines inter-well connectivity by using the degree of influence of different injection wells on a production well.

4. The present disclosure establishes a reservoir-oriented injection-production optimization method, in which the injection volume, injection pressure and injection mode of each injection well are taken as inputs, and the oil production and gas-oil ratio of the target well as outputs. With a relation model between the injection volume and injection pressure and a boundary condition as constraints, the injection-production system surrogate model as a basis, and the evaluation function as an optimization direction, reservoir production optimization schemes are searched, and the optimal solutions under different targets are analyzed according to Pareto front solution sets.

### BRIEF DESCRIPTION OF THE DRAWINGS

In order to describe the technical solutions in the examples of the present disclosure more clearly, the accompanying drawings required to describe the examples are briefly described below. Apparently, the accompanying drawings described below are only some examples of the present disclosure. Those of ordinary skill in the art may further obtain other accompanying drawings based on these accompanying drawings without inventive effort.

FIG. 1 is a schematic diagram of an implementation process of a reinforcement learning-based decision optimization method of an oilfield production system according to an embodiment of the present disclosure;

FIG. 2 is a schematic diagram of prediction results of the daily oil production of the injection-production surrogate model according to an embodiment of the present disclosure;

FIG. 3 is a schematic diagram of the importance analysis of input parameters and inter-well connectivity according to an embodiment of the present disclosure;

FIG. 4 is a schematic diagram of an optimization direction for production and development of a gas injection reservoir according to an embodiment of the present disclosure;

FIG. 5 is a schematic diagram of a Pareto front solution set for reservoir production optimization according to an embodiment of the present disclosure; and

FIG. 6 is a schematic diagram of an exemplary application of the reinforcement learning-based decision optimization method according to the present disclosure.

### DETAILED DESCRIPTION OF THE EMBODIMENTS

In order to make the objectives, technical solutions and advantages of the present invention clearer, embodiments of the present invention will be further described in detail below with reference to the accompanying drawings.

This embodiment provides a reinforcement learning-based decision optimization method of an oilfield production system. The method is implemented solely based on real on-site monitoring data, and with physical and operational limitations taken into consideration, the injection-production system surrogate model and production optimization framework are established by an integrated machine learning method, so as to solve the problem of injection optimization in the process of oilfield development and provide more effective selection and guidance for decision-makers, thereby achieving the goal of cost decreasing and benefit increasing.

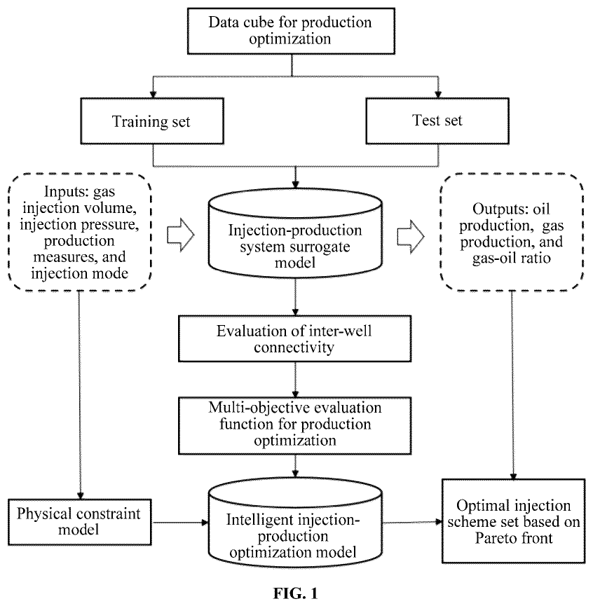

According to the decision optimization method of an oilfield production system provided by this embodiment, firstly, the reservoir injection-production system surrogate model is established based on real on-site monitoring data and machine learning to replace complex traditional numerical simulators without considering complex geological structure and multiphase seepage mechanism, and then sensitivity of input parameters to the model is determined based on the surrogate model, which thus provides an evaluation method for inter-well connectivity. Then an evaluation function for production optimization of a gas injection reservoir is constructed, with a relation model between the injection volume and injection pressure and a boundary constraint condition as constraints, the reinforcement learning-based reservoir injection-production system surrogate model as a basis, and the evaluation function as an optimization direction, reservoir production optimization schemes are searched, and an intelligent injection-production optimization model is established. By reference to the idea diagram as shown in FIG. 1, the method includes the following steps:

S1, collecting on-site dynamic production data to establish a data cube for reservoir production optimization;

S2, training a preset machine learning model based on the established data cube to obtain a reinforcement learning-based reservoir injection-production system surrogate model configured to predict oil production according to the on-site dynamic production data;

S3, based on the reservoir injection-production system surrogate model, quantitatively characterizing connectivity between an injection well and a production well;

S4, constructing an evaluation function for production optimization of a gas injection reservoir;

S5, establishing, during a process of production optimization, an enforced constraint model based on input parameters and a boundary constraint condition; and

S6, with the constraint model and the boundary constraint condition as constraints, the reservoir injection-production system surrogate model as a basis, and the evaluation function as an optimization direction, searching reservoir production optimization schemes for an optimal production scheme.

The following steps are explained in detail one by one in combination with FIGS. 2 to 5.

Step 1, collect on-site dynamic production data to establish a data cube for reservoir production optimization: firstly, collecting dynamic production data from reservoir production wells (target wells) and neighboring injection wells (gas injection wells): where data of the production wells include: oil production (Qo), gas production (Qg), gas-oil ratio (GOR), well status of shut-in and producing (SI) and choke size (CS); and data of the injection wells include: gas injection volume (IV), injection pressure (IP), and injection mode (IM). Regarding the well status of shut-in and producing, 0/1 is used to represent well shut-in/well producing, and regarding the injection mode, 001/010/100 is used to represent ceased injection/gas injection/water injection. In this experiment, take a five-spot well pattern, namely one production well and surrounding four injection wells, as an example: a data set of the production wells can be expressed as A=[Qo^{t},Qg^{t}, GOR^{t},SI^{t}, CS^{t}], a data set of the injection wells can be expressed as B=[IV^{w,t},IP^{w,t},IM^{w,t}], where w and t denote a well number (#1, #2, #3 and #4) and a development period (covering a range of 4,500 days), respectively, and in this way, a data cube for reservoir production optimization is formed.

Step 2, train a preset machine learning model based on the established data cube to obtain a reinforcement learning-based reservoir injection-production system surrogate model configured to predict oil production according to the on-site dynamic production data; extract from the constructed data cube a data set D=[A,B] with a total sample size of 4500 required for model training, divide the data set into training sets D^{train}=[A¹⁻⁴⁰⁰⁰,B¹⁻⁴⁰⁰⁰] and test sets D^{test}=[^{A4001-4500},B⁴⁰⁰¹⁻⁴⁵⁰⁰] in a ratio of 9:1, where 1-4000 indicates a time range from day 1 to day 4,000; in the meanwhile, for both the training sets and the test sets, the input and output thereof need to be defined for the training and verification of a model, that is, training set D^{train}=[X^{train},Y^{train}] and test set D^{test}=[X^{test},Y^{test}], where X and Y denote input and output parameters, respectively, X=[SI^{t}, CS^{t}, IV^{w,t}, IP^{w,t}, IM^{w,t}], and Y=[Qo^{t}, Qg^{t}, GOR^{t}]. Construct a deep neural network-based (DNN-based) machine learning model, where the machine learning model has 3 hidden layers, with each layer having 60 neurons, which can be expressed as F(D; W, θ); where W denotes a connecting weight among neurons, θ denotes a threshold value in each neuron, and D denotes a data set required for the machine learning model. According to the core of the machine learning model, through input and output parameters of the data set, the weight and threshold value in the model are constantly adjusted by using a back propagation algorithm, so that the prediction result can constantly approach an actual value. Finally, the reinforcement learning-based reservoir injection-production system surrogate model F can be obtained, and prediction results of the training sets and test sets can be respectively expressed as:

Y_pred^{train}=[Qo_pred^{t_train},Qg_pred^{t_train},GOR_pred^{t_train}]

Y_pred^{test}=[Qo_pred^{t_test},Qg_pred^{t_test},GOR_pred^{t_test}]

FIG. 2 shows a prediction result of the injection-production surrogate model for daily oil production, where horizontal axis denotes an actual daily oil production, and longitudinal axis denotes a predicted daily oil production. As can be seen, the relative error falls essentially within 15%, and both the test sets and the training sets exhibit excellent prediction performance.

Step 3, based on the reservoir injection-production system agent model, quantitatively characterize connectivity between an injection well and a production well; and form an evaluation method for inter-well connectivity based on the reservoir injection-production system surrogate model. The injection-production system surrogate model conducts historical fitting on true on-site monitoring data by way of reinforcement learning, and contrastive analysis based on the prediction result proves that the model has already learned a nonlinear characteristic relation between data, and possesses high accuracy rate and confidence level. The input data of the model include the injection volume, injection pressure and injection mode of 4 injection wells, and the production measures of 1 production well, including choke size and well status of shut-in and producing, covering a total of 14 variables. Firstly, calculate importance of each variable to the model, namely, randomly change the sequence of data of a certain variable in an input set while keeping other variables constant so as to construct anew training set, such as D_SI=[R(SI^{t}), CS^{t}, IV^{w,t},IP^{w,t},IM^{w,t}], where R denotes a random function, and D_SI denotes a data set in which the variable well status of shut-in and producing (SI) is changed. The machine learning model is trained with the new data set, and error of the corresponding prediction result is calculated. The difference value between the error and the prediction error of the machine learning model trained based on an original data set can be expressed as follows:

E(SI)=MAE[F(D_SI,W,θ)]−MAE[F(D,W,θ)]

E (SI) denotes the sensitivity of parameter well status of shut-in and producing, MAE denotes an average absolute error function, and F denotes an injection-production system surrogate model. Based on the above method, the sensitivity of each parameter to the model can be calculated, and the connectivity between the injection well and the production well can be expressed as:

$${L}_{\#01} = \frac{E ( {IV}_{\#01} ) + E ( {IP}_{\#01} ) + E ( {IM}_{\#01} )}{{\sum }_{i = 1}^{4} ( E ( {IV}_{i} ) + E ( {IP}_{i} ) + E ( {IM}_{i} ) )}$$

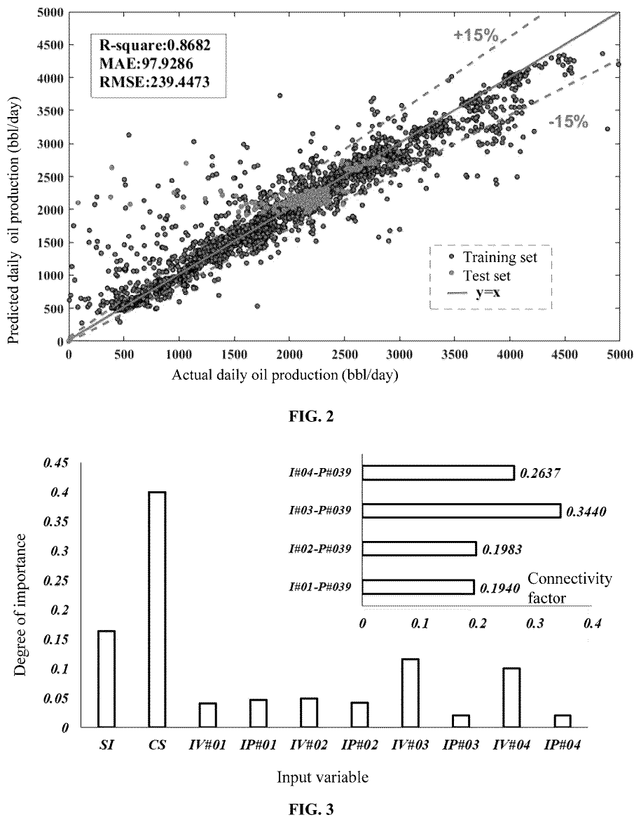

L_{#01} denotes connectivity factors between the first injection well and the production well. There are 4 injection wells in the five-spot well pattern, so the maximum value of i is 4. By the above method, the connectivity between an injection well and a production well can be quantitatively characterized. FIG. 3 shows calculation results of the sensitivity of input parameters to the model and the connectivity between injection and production wells for a set of five-spot well pattern.

Step 4, construct an evaluation function for production optimization of a gas injection reservoir; high gas-oil ratio (GOR) in gas injection development reservoir will pose safety hazards, and some corrosive acid gas will destroy pipelines and other infrastructure, and easily cause gas breakthrough and other phenomena, which is not conducive to the sustainable development of the reservoir. Therefore, in the process of oil-gas field development, it is often hoped that the oil production can be increased as much as possible under the condition of a low gas-oil ratio, so that the economic benefit can be increased under the premise of sustainable development. Therefore, one objective of this project is large oil production, which can be expressed as Obj_01=MAX(Qo), and the other objective is low gas-oil ratio, which can be expressed as Obj_02=MIN(GOR). In order to meet the above two objectives, the evaluation function for production optimization of gas injection reservoir is constructed as follows:

$$O ( x ) = exp \{ \frac{{Qo}_{( f ( D , W , θ ) )}}{G O {R}_{( f ( D , W , θ ) )} + 1} \}$$

where O(x) denotes an evaluation function, Qo denotes oil production, GOR denotes gas-oil ratio, and exp { } denotes an exponential function which can be used to enlarge the change scope of the ratio.

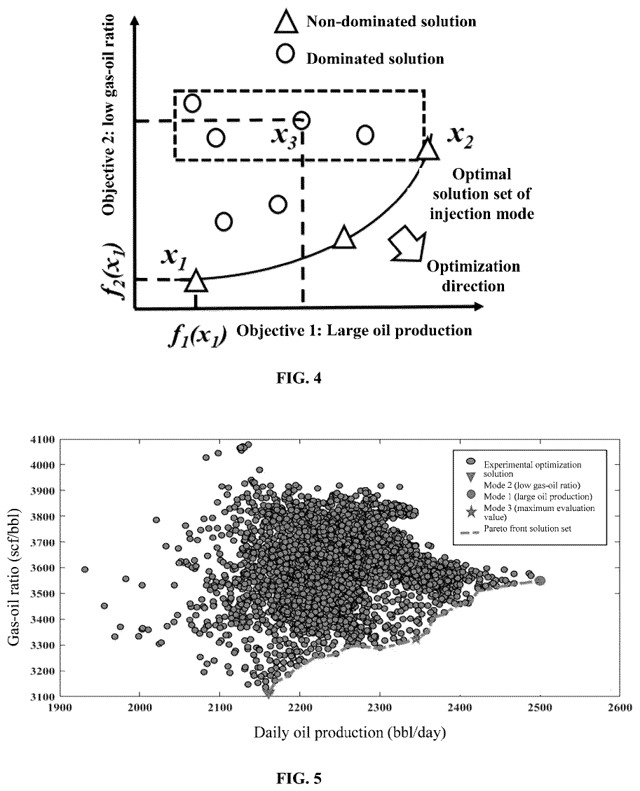

Based on the evaluation function, the optimization direction of the optimization problem can be defined. As shown in FIG. 4, the optimization direction of reservoir production optimization based on the evaluation function under two objectives is shown in detail, which makes it convenient to find the optimal solution set.

Step 5, establish, during a process of production optimization, an enforced constraint model based on input parameters and a boundary constraint condition. In the actual production process, there is an implicit relationship between the injection volume and the injection pressure of each injection well, that is, the greater the injection volume, the higher the injection pressure. However, in the process of optimization, values may be randomly assigned to the injection volume and injection pressure as two irrelevant variables, and therefore, injection volume and injection pressure of different injection wells obtained under this optimization mechanism obviously do not meet the actual production requirements. Therefore, it is necessary to establish a physical constraint model between injection volume and injection pressure, that is, with injection volume as an input and injection pressure as an output, an intelligent constraint model S which can be used to predict injection pressure using injection volume is constructed through the machine learning model. The relationship between injection volume and injection pressure can be expressed as follows:

IP_pred^{w,t}=S(IV^{w,t},W,θ)

where IP_pred^{w,t} denotes an injection pressure prediction value of a wth injection well at moment t, w denotes a well number, t denotes a mining time, IV^{w,t} denotes an injection volume of the wth injection well at moment t, W denotes a weight among neurons of a machine learning model, and θ denotes a threshold value in the neurons. Besides, for the input variables corresponding to the injection well in the optimization model, a boundary constraint condition is still required, which can be expressed as follows:

IV^{w,t}∈{a*Ave(IV),b*Max(IV)},IP^{w,t}∈{Min(IP),Max(IP)}

where a and b are constraint factors, which respectively have a value range a ∈(0,1) and b ∈(0.5,2); IP^{w,t} denotes injection pressure of a wth injection well at moment t; Ave(IV) denotes an average value of injection volume, Max(IV) denotes a maximum value of injection volume, Min(IP) denotes a minimum value of injection pressure, and Max(IP) denotes a maximum value of injection pressure.

In addition, a constraint condition of a choke size in production measures may be expressed as:

CS^{t}∈{0,AVE(CS)+c*(MAX(CS)−MIN(CS))}

where CS^{t} denotes a choke size of a production well at moment t; AVE (CS) denotes an average value of choke size; c denotes a flow coefficient, MAX(CS) denotes a maximum value of choke size, and MIN(CS) denotes a minimum value of choke size.

Step 6, with the constraint model and the boundary constraint condition as constraints, the reservoir injection-production system surrogate model as a basis, and the evaluation function as an optimization direction, search reservoir production optimization schemes for an optimal production scheme; establish an injection-production optimization model based on a particle swarm optimization algorithm, where inputs of the model include injection volume, injection pressure and injection mode of each injection well, and outputs include oil production and gas-oil ratio of a target well; and with a relation model between the injection volume and injection pressure and a boundary constraint condition as constraints, the injection-production system surrogate model as a basis, and the evaluation function as an optimization direction, search reservoir production optimization schemes. Further, optimize different injection schemes, calculate, based on the optimized injection modes, oil production and gas-oil ratio of a production well under corresponding conditions by using the injection-production surrogate model, search for Pareto front aiming at reservoir production optimization, and with the Pareto front as an optimal solution set of the optimization problem, select and optimize the schemes to meet different requirements. In the embodiment, such requirements are large oil production and/or low gas-oil ratio. When it is desired to obtain a large oil production, a point with large oil production is searched along the Pareto front, and when it is desired to obtain a low gas-oil ratio, a point with low gas-oil ratio is searched along the Pareto front. Specifically, for example, when it is desired to obtain the largest oil production, a point with the largest oil production is searched along the Pareto front, so as to obtain the gas injection volume, injection pressure and injection mode from the corresponding injection scheme at the point for injecting. FIG. 5 shows the prediction effect of different injection modes after optimization by an intelligent injection-production optimization model. The horizontal axis represents oil production, and the vertical axis represents gas-oil ratio. The Pareto front solution set can be obtained according to the optimization direction; the maximum oil production can be reached under injection mode 1, and the optimal gas-oil ratio can be obtained under injection mode 2. By using the solution set, the injection scheme can be adjusted according to different needs of the site.

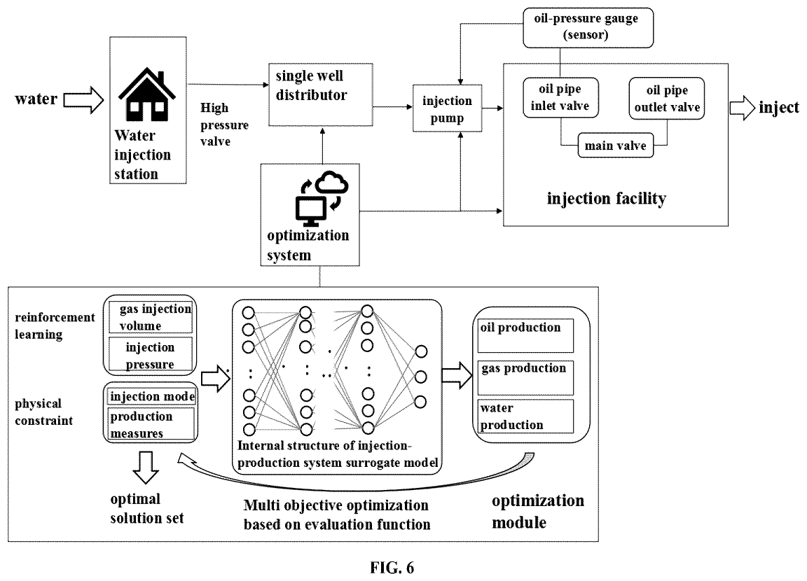

As shown in FIG. 6, the present disclosure provides a reinforcement learning-based decision optimization method of an oilfield production system, which can be packaged into an optimization module so as to be integrated into an optimization system for oilfield development. In the use, such optimization module can be used to quickly and efficiently obtain the injection scheme including gas injection volume, injection pressure and injection mode, to control the injection well equipment, including single well distributor, injection pump and injection facility. The optimization module can not only improve the optimization efficiency in the oilfield development process, but also realize the intelligent optimization of oilfield production. The optimization system transfers the gas injection volume to the single well distributor, which distributes gas according to the optimized gas injection volume and injects the gas into the injection well. Further, the oil-pressure gauge monitors and feeds back a pressure of the injection well in time, and the optimization system controls the injection pump based on the fed pressure and the optimized injection pressure, to adjust the pressure of the injection well to the optimized injection pressure. Furthermore, the optimization system controls the injection facility including oil pipe inlet valve, oil pipe outlet valve and main valve, according to the optimized injection mode.

To sum up, embodiments of the present disclosure innovatively propose a reinforcement learning-based decision optimization method of an oilfield production system. The method can establish an injection-production system surrogate model solely based on the real on-site monitoring data regardless of complex geological model or flow mechanism, which can replace the traditional numerical simulator; in the meanwhile, the reinforcement learning-based optimization algorithm can quickly and accurately determine the optimal injection mode, and possesses high prediction accuracy and strong adaptability with a prediction speed on the order of seconds, thereby well solving the production optimization problem of complex oilfields.

In addition, it should be noted that the present disclosure may be provided as a method, an apparatus, or a computer program product. Therefore, the embodiments of the present invention may be in a form of hardware only embodiments, software only embodiments, or embodiments with a combination of software and hardware. Moreover, the embodiments of the present invention may be in a form of a computer program product that is implemented on one or more computer-usable storage media that include computer-usable program code.

The embodiments of the present invention are described with reference to the flowcharts and/or block diagrams of the method, the terminal device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, an embedded processor, or a processor of another programmable data processing terminal device to generate a machine, so that the instructions executed by a computer or a processor of another programmable data processing terminal device generate an apparatus for implementing a specific function in one or more processes in the flowcharts and/or in one or more blocks in the block diagrams.

These computer program instructions may also be stored in a computer readable memory that can instruct the computer or another programmable data processing terminal device to work in a specific manner, so that the instructions stored in the computer readable memory generate an artifact that includes an instruction apparatus. The instruction apparatus implements a specific function in one or more processes in the flowcharts and/or in one or more blocks in the block diagrams. These computer program instructions may also be loaded onto a computer or another programmable data processing terminal device, so that a series of operations and steps are performed on the computer or the another programmable terminal device, thereby generating computer-implemented processing. Therefore, the instructions executed on the computer or the another programmable terminal device provide steps for implementing a specific function in one or more processes in the flowcharts and/or in one or more blocks in the block diagrams.

It should be noted that terms “including”, “comprising” or any other variants thereof are intended to cover non-exclusive inclusion, so that a process, method, article, or terminal device including a series of elements includes not only those elements but also other elements not explicitly listed, or elements inherent to such a process, method, article, or terminal device. Without more restrictions, the elements defined by the sentence “including a . . . ” do not exclude the existence of other identical elements in the process, method, article, or terminal device including the elements.

Finally, it should be noted that the foregoing descriptions are preferred implementations of the present disclosure. It should be noted that although the preferred embodiments of the present disclosure have been described, those skilled in the art, once knowing the basic inventive concept of the present disclosure, can further make several improvements and modifications without departing from the principle of the present disclosure, and these improvements and modifications should also be considered as falling within the protection scope of the present disclosure. Therefore, the appended claims are intended to be construed as covering the preferred embodiments and all changes and modifications falling within the scope of the embodiments of the present invention.

What is claimed is:

1. A reinforcement learning-based decision optimization method of an oilfield production system, comprising the following steps:
collecting on-site dynamic production data to establish a data cube for reservoir production optimization;
training a preset machine learning model based on the data cube to obtain a reinforcement learning-based reservoir injection-production system surrogate model configured to predict oil production according to the on-site dynamic production data;
constructing an evaluation function for production optimization of a gas injection reservoir;
establishing, during a process of production optimization, an enforced constraint model based on input parameters and a boundary constraint condition;
with the constraint model and the boundary constraint condition as constraints, the reservoir injection-production system surrogate model as a basis, and the evaluation function as an optimization direction, searching reservoir production optimization schemes as optimal production schemes; and
selecting one optimal production scheme from the optimal production schemes according to actual requirements, obtaining an injection scheme corresponding to the one optimal production scheme, and controlling injection well equipment for injecting according to the injection scheme.

2. The reinforcement learning-based decision optimization method of an oilfield production system according to claim 1, wherein after obtaining the reservoir injection-production system surrogate model, the method further comprises:
based on the reservoir injection-production system surrogate model, quantitatively characterizing connectivity between an injection well and a production well.

3. The reinforcement learning-based decision optimization method of an oilfield production system according to claim 2, wherein said quantitatively characterizing connectivity between an injection well and a production well specifically comprises:
calculating importance of each input variable of the reservoir injection-production system surrogate model to the model, namely, randomly changing the sequence of data of a certain variable in a data set while keeping other variables constant so as to construct a new training set, training the model with the new data set, and calculating an error of a corresponding prediction result;
calculating a difference value between a prediction error of the model trained based on the new data set and a prediction error of a model trained based on an original data set as sensitivity of a corresponding variable in a data set to a model; and
calculating the connectivity between an injection well and a production well through the following formula:
$${L}_{j} = \frac{E ( {IV}_{j} ) + E ( {IP}_{j} ) + E ( {IM}_{j} )}{{\sum }_{i = 1}^{4} ( E ( {IV}_{i} ) + E ( {IP}_{i} ) + E ( {IM}_{i} ) )}$$
wherein Lⱼ denotes a connectivity factor between a jth injection well and a production well, E(IVⱼ) denotes sensitivity of a gas injection volume of the jth injection well to a model, E(IPⱼ) denotes sensitivity of injection pressure of the jth injection well to the model, and E (IMⱼ) denotes sensitivity of an injection mode of the jth injection well to the model.

4. The reinforcement learning-based decision optimization method of an oilfield production system according to claim 1, wherein said collecting on-site dynamic production data to establish a data cube for reservoir production optimization specifically comprises:
collecting dynamic production data from reservoir production wells and neighboring injection wells, wherein the dynamic production data of the production wells comprise: oil production, gas production, gas-oil ratio, well status of shut-in and producing, and choke size, and the dynamic production data of the injection wells comprise: gas injection volume, injection pressure, and injection mode; and
establishing the data cube for reservoir production optimization by using the collected dynamic production data.

5. The reinforcement learning-based decision optimization method of an oilfield production system according to claim 4, wherein said training a preset machine learning model based on the data cube to obtain a reinforcement learning-based reservoir injection-production system surrogate model configured to predict oil production according to the on-site dynamic production data specifically comprises:
extracting from the data cube a data set required for model training, and dividing the data set into training sets and test sets in a ratio of 9:1, wherein in the data set, the well status of shut-in and producing and choke size of the production wells, as well as the gas injection volume, injection pressure and injection mode of the injection wells are taken as inputs of the model, and oil production, gas production and gas-oil ratio of the production wells are taken as outputs of the model;
constructing a deep neural network-based (DNN-based) machine learning model, wherein the machine learning model has 3 hidden layers, with each layer having 60 neurons; and
training the machine learning model by adopting the training sets, and testing the trained machine learning model by adopting the test sets to obtain the reinforcement learning-based reservoir injection-production system surrogate model.

6. The reinforcement learning-based decision optimization method of an oilfield production system according to claim 1, wherein the evaluation function is expressed as follows:
$$O ( x ) = exp \{ \frac{{Qo}_{( f ( D , W , θ ) )}}{G O {R}_{( f ( D , W , θ ) )} + 1} \}$$
wherein O(x) denotes an evaluation function, Qo_{(f(D,W,θ))} denotes oil production, and GOR_{(f(D,W,θ))} denotes a gas-oil ratio.

7. The reinforcement learning-based decision optimization method of an oilfield production system according to claim 6, wherein said establishing an enforced constraint model based on input parameters and a boundary constraint condition specifically comprises:
establishing a physical constraint model between injection volume and injection pressure, that is, constructing, with injection volume as an input and injection pressure as an output, and by a machine learning model, an intelligent constraint model S which can predict injection pressure with the injection volume, wherein a relationship between the injection volume and injection pressure is represented as follows:
IP_pred^{w,t}=S(IV^{w,t},W,θ)
wherein IP_pred^{w,t} denotes an injection pressure prediction value of a wth injection well at moment t, IV^{w,t} denotes an injection volume of the wth injection well at moment t, W denotes a weight among neurons of a machine learning model, and θ denotes a threshold value in the neurons; besides, a following boundary constraint condition is set for input variables corresponding to the injection well:
IV^{w,t}∈{a*Ave(IV),b*Max(IV)},IP^{w,t}∈{Min(IP),Max(IP)}
wherein a and b are constraint factors, which respectively have a value range a∈(0,1) and b ∈(0.5,2); IP^{w,t} denotes injection pressure of a wth injection well at moment t; Ave (IV) denotes an average value of injection volume, Max(IV) denotes a maximum value of injection volume, Min(IP) denotes a minimum value of injection pressure, and Max(IP) denotes a maximum value of injection pressure; and
in addition, a boundary constraint condition of a choke size in production measures is expressed as:
CS^{t}∈{0,AVE(CS)+c*(MAX(CS)−MIN(CS))}
wherein CS^{t} denotes a choke size of a production well at moment t; AVE(CS) denotes an average value of choke size; c denotes a flow coefficient, MAX(CS) denotes a maximum value of choke size, and MIN(CS) denotes a minimum value of choke size.

8. The reinforcement learning-based decision optimization method of an oilfield production system according to claim 7, wherein said with the constraint model and the boundary constraint condition as constraints, the reservoir injection-production system surrogate model as a basis, and the evaluation function as an optimization direction, searching reservoir production optimization schemes for an optimal production scheme specifically comprises:
establishing an injection-production optimization model based on a particle swarm optimization algorithm, wherein inputs of the injection-production optimization model comprise injection volume, injection pressure and injection mode of each injection well, and outputs comprise oil production and gas-oil ratio of a target well;
with a relation model between the injection volume and injection pressure and a boundary constraint condition as constraints, the reinforcement learning-based reservoir injection-production system surrogate model as a basis, and the evaluation function as an optimization direction, searching reservoir production optimization schemes; and
optimizing different injection schemes, calculating, based on the optimized injection scheme, oil production and gas-oil ratio of a production well under corresponding conditions by using the injection-production system surrogate model, searching for Pareto front aiming at reservoir production optimization to obtain the optimal production schemes.

9. The reinforcement learning-based decision optimization method of an oilfield production system according to claim 8, wherein the injection scheme comprises a gas injection volume, an injection pressure and an injection mode, the injection well equipment comprises a single well distributor, an injection pump and injection facility, and the injection facility comprises oil pipe inlet valve, oil pipe outlet valve and main valve;
wherein the reinforcement learning-based decision optimization method further comprises:
selecting the one optimal production scheme from the Pareto front according to the actual requirements;
obtaining the injection scheme corresponding to the one optimal production scheme; and
distributing, by the single well distributor, gas according to the gas injection volume, controlling the injection pump based on the injection pressure, and controlling the injection facility according to the injection mode.
